(19) United States
(12) Patent Application Publication
(10) Pub. No.: US 2016/0318115 A1
(43) Pub. Date: Nov. 3, 2016

(54) WELDING PROCESS

(71) Applicant: Lincoln Global, Inc., City of Industry, CA (US)

(72) Inventor: James M. Keegan, Chardon, OH (US)

(73) Assignee: Lincoln Global, Inc., City of Industry, CA (US)

(21) Appl. No.: 15/137,085

(22) Filed: Apr. 25, 2016

Related U.S. Application Data
(60) Provisional application No. 62/155,522, filed on May 1, 2015.

(51) Int. Cl. B23K 9/173; B23K 35/02; B23K 9/24

(52) U.S. Cl. CPC B23K 9/173; B23K 9/24; B23K 35/0266

(57) ABSTRACT

The invention described herein generally pertains to an improved process in the field of welding using longer than recommended contact-to-work-distances coupled with effectively reduced shielding gas flow rates by adding between 0.25-10 parts of at least one porosity reducing agent to the electrode composition comprising a lime-fluoride based slag, selected from the group consisting of: (a) at least one metallic nitride former selected from the group consisting of Ti, Zr, Ca, Ba and Al, including metallic alloys thereof or alloys which incorporate at least one of the identified metals, and further wherein when no Al is present in the at least one metallic nitride former, a Li compound is substituted; or (b) at least one rare earth metal selected from the group consisting of La, Ce, Pr, Nd, Pm, Sm, Eu, Gd, Tb, Dy, Ho, Er, Tm, Yb, Lu, Sc and Y, including combinations of (a) and (b).

### TECHNICAL FIELD

The invention described herein pertains generally to an improved process for welding using longer than recommended contact-to-work-distances coupled with reduced shielding gas flow rates and welding compositions to achieve the same.

### BACKGROUND OF THE INVENTION

When welding and joining heavy section plates using excessive contact-to-work-distance (“CTWD”) in comparison to the recommended distance (e.g., as high as 2.5″ when a recommended distance would be for example, 1%″) and using excessive voltage (e.g., as high as 36 volts) and higher than recommended shielding gas rates (resulting in an effectively lowered shielding gas rate due to turbulence), all of the above resulting in internal weld bead porosity when using a T5 welding electrode.

Without being held to any one theory or mode of operation, it is believed that at least one of the causes of this porosity is excessive nitrogen in the molten weld puddle.

### SUMMARY OF THE INVENTION

In accordance with the present invention, there is provided a process to reduce the porosity of a weld bead which is made outside of the recommended contact-to-work distance using a flux-cored shielded electrode comprising the step of adding at least one porosity reducer selected from the group consisting of (a) at least one metallic nitride former or (b) at least one rare earth compound to the electrode composition, the preceding “or” used in the disjunctive sense as well as combinations of (a) and (b), the preceding “and” used in the conjunctive sense.

In one aspect of the invention, the at least one metallic nitride former is selected from the group consisting of Ti, Zr, Ca, Ba and Al, including metallic alloys thereof or alloys which incorporate at least one of the identified metals.

In another aspect of the invention, the metallic alloys of the at least one nitride former comprise an Al/Zr powder alloy (50/50) and a Ca/Si/Ba powder alloy (4-19% Ca/45-65% Si/8-18% Ba/9% max Fe/1% max Al).

It is further noted in yet another aspect of the invention, that the addition of a rare earth metal improves the nitriding characteristics. As used in this application, rare earth metals, often in the silicide or oxide form, include: a set of seventeen chemical elements in the periodic table, specifically the fifteen lanthanides: La, Ce, Pr, Nd, Pm, Sm, Eu, Gd, Tb, Dy, Ho, Er, Tm, Yb & Lu; as well as Sc and Y. Scandium and yttrium are considered rare earth elements because they tend to occur in the same ore deposits as the lanthanides and exhibit similar chemical properties. Despite their name, rare earth elements are—with the exception of radioactive promethium—relatively plentiful in Earth's crust. They tend to occur together in nature and are difficult to separate from one another. However, because of their geochemical properties, rare earth elements are typically dispersed and not often found concentrated as rare earth minerals in economically exploitable ore deposits.

In a further aspect of the invention, there is provided an electrode composition for a T5 flux-cored shielded electrode which meets H4 diffusible hydrogen levels as illustrated in Table I. The electrode compositions which have a designation of T5, as used in this application, will be used with a CO₂ shielding gas, although the electrodes may be used with a blend of CO₂ and Ar to reduce spatter. It should be further noted that as used in this application, these electrodes have a lime-fluoride base slag (CaF₂).

TABLE I

| Component | Parts |
|---|---|
| Cast Iron Powder | 3.5-5 |
| Fe | 50-60 |
| TiO₂ | 0.4-1.0 |
| Mn | 3.2-4.2 |
| Ferro Silicon (47-52% Si) | 0.15-0.35 |
| Ferromanganese Silicon (59-63% Mn/29-32% Si) | 8.6-12.6 |
| CaF₂ | 18-22 |
| K₂TiO₃ | 3.0-7.0 |
| at least one porosity reducer | 0.25-10.0 |
| Totals | 100 |

What is described herein is a process to reduce the porosity of a weld bead which is made outside of the recommended contact-to-work distance using a flux-cored shielded T5 electrode, the weld made from the T5 electrode having a diffusible hydrogen as measured in mL/100 g weld deposit of less than or equal to 4.0 comprising the step of: adding between 0.25-10 parts of at least one porosity reducing agent to the electrode composition comprising a lime-fluoride based slag, selected from the group consisting of: (a) at least one metallic nitride former selected from the group consisting of Ti, Zr, Ca, Ba and Al, including metallic alloys thereof or alloys which incorporate at least one of the identified metals, and further wherein when no Al is present in the at least one metallic nitride former, a Li compound is substituted; or (b) at least one rare earth metal selected from the group consisting of La, Ce, Pr, Nd, Pm, Sm, Eu, Gd, Tb, Dy, Ho, Er, Tm, Yb, Lu, Sc and Y, including combinations of (a) and (b).

In the above process, the Li compound is selected from the group consisting of Li₂CO₃ and LiF, preferably LiF. In the process, the metallic alloys of the at least one nitride former include an Al/Zr powder alloy and a Ca/Si/Ba powder alloy. In one aspect of the invention, the process of claim will include the addition of at least one rare earth metal is selected from the group consisting of cerium and lanthanum.

In composition, a flux-cored shielded electrode having a diffusible hydrogen in a weld derived from the electrode of less than or equal to 4.0 mL/100 g weld deposit, the electrode comprising at least one porosity reducing agent, the electrode forming a lime-fluoride based slag, the at least one porosity reducing agent selected from the group consisting of (a) at least one metallic nitride former selected from the group consisting of Ti, Zr, Ca, Ba and Al, including metallic alloys thereof or alloys which incorporate at least one of the identified metals, and further wherein when no Al is present in the at least one metallic nitride former, a Li compound is substituted; or (b) at least one rare earth metal selected from the group consisting of La, Ce, Pr, Nd, Pm, Sm, Eu, Gd, Tb, Dy, Ho, Er, Tm, Yb, Lu, Sc and Y, including combinations of (a) and (b).

The Li compound is selected from the group consisting of Li₂CO₃ and LiF, preferably LiF. The metallic alloys of the at least one nitride former include an Al/Zr powder alloy and a Ca/Si/Ba powder alloy. The at least one rare earth metal is preferably selected from the group consisting of lanthanum and cerium.

In another aspect of the invention, a process is described to reduce the porosity of a weld bead which is made outside of the recommended contact-to-work distance using a flux-cored shielded T5 electrode, said weld made from the T5 electrode having a diffusible hydrogen as measured in mL/100 g weld deposit of less than or equal to 4.0 comprising the step of: adding between 0.25-10 parts of at least one porosity reducing agent to the electrode composition comprising a lime-fluoride based slag, the at least one porosity reducing agent comprising at least one rare earth metal selected from the group consisting of La, Ce, Pr, Nd, Pm, Sm, Eu, Gd, Tb, Dy, Ho, Er, Tm, Yb, Lu, Sc and Y.

In the process the flux-cored shielded electrode further includes a Li compound selected from the group consisting of Li₂CO₃ and LiF, preferably LiF. The at least one rare earth metal is preferably selected from the group consisting of cerium and lanthanum.

In yet a further aspect of the invention, a flux-cored shielded electrode is described having a diffusible hydrogen in a weld derived from the electrode of less than or equal to 4.0 mL/100 g weld deposit, the electrode comprising at least one porosity reducing agent, the electrode forming a lime-fluoride based slag, and wherein the at least one porosity reducing agent includes: at least one rare earth metal selected from the group consisting of La, Ce, Pr, Nd, Pm, Sm, Eu, Gd, Tb, Dy, Ho, Er, Tm, Yb, Lu, Sc and Y.

The Li compound is typically selected from the group consisting of Li₂CO₃ and LiF, preferably LiF while the at least one rare earth metal is selected from the group consisting of lanthanum and cerium.

These and other objects of this invention will be evident when viewed in light of the drawing, detailed description and appended claims.

### BRIEF DESCRIPTION OF THE DRAWING

FIG. 1 is a graph of nitrogen taken from single pass welds using different electrodes in which the weld bead was drilled two inches from the end of the end weld bead, and wherein the welding conditions employed were CTWD=2.5″; Wire Feed Speed (“WFS”)=300 ipm; Voltage=36 v; Travel Speed=11.9 ipm; Amperage=˜450 amps; a CO₂ gas flow rate of 35 CFH; and a wire diameter of 3/32″.

### DETAILED DESCRIPTION OF THE INVENTION

The best mode for carrying out the invention will now be described for the purposes of illustrating the best mode known to the applicant at the time of the filing of this patent application. The examples and FIGURE are illustrative only and not meant to limit the invention, which is measured by the scope and spirit of the claims.

Unless the context clearly indicates otherwise: the word “and” indicates the conjunctive; the word “or” indicates the disjunctive; when the article is phrased in the disjunctive, followed by the words “or both” or “combinations thereof” both the conjunctive and disjunctive are intended.

Porosity in the molten weld puddle may be caused by many factors, at least one of which includes the presence of excessive nitrogen. One approach to reduce the nitrogen levels is to combine the nitrogen in the molten state. This is done by the addition of at least one metallic nitride former, e.g., addition of metallic Ti, Zr, Ca, Ba and Al, and metallic alloys thereof or alloys which incorporate at least one of the identified metals or by the addition of at least one rare earth mineral, or both additions. The nitride formers combine with the available nitrogen in solution and float out into the slag. There may be some nitrides present in the solid solution after the welding is complete. By using the compositions of the present invention, the amount of weld metal nitrogen was capable of being reduced by 25-55% as compared with the standard Lincoln Electric Company UltraCore® 75C flux-cored electrode product. In the absence of Al in the electrode, it is possible to substitute lithium carbonate (Li₂CO₃) and lithium fluoride (LiF), although it is noted that Li₂CO₃ absorbs water and tends to increase weld metal hydrogen content, therefore, it is not preferred.

The addition of LiF appears to impact the ball transfer size in the welding arc, in some instances, making the ball more spherical and provide additional shielding to the arc plasma that may further result in lowering the porosity.

Lincoln Electric's UltraCore® 75C is a T5 welding electrode designed for high deposition in the flat and horizontal positions achieving H4 diffusible hydrogen levels. It is typically used for welding with 100% CO₂ as a shielding gas for premium arc performance and bead appearance. The flow rate is recommended between 40-55 CFH.

As used in this application, a T5 welding electrode will include a T5 flux-cored shielded electrode which meets H4 diffusible hydrogen levels as illustrated in Table II. The electrode compositions which have a designation of T5, as used in this application, will be used with a CO₂ shielding gas, although the electrodes may be used with a blend of CO₂ and Ar to reduce spatter. It should be further noted that as used in this application, these electrodes have a lime-fluoride base slag (CaF₂).

Additionally, as used in this application, the lime-based slag or CaF₂, which forms will preferably comprise approximately 80% of the slag system.

As used in this application, the term “approximately” is within 10% of the stated value, except where noted.

Lincoln Electric UltraCore® 75C welding electrodes are typically sold in the following wire diameters listed in both inches and in parentheses, mm: 1/16″ (1.6), 5/64″ (2.0) and 3/32″ (2.4). The mechanical properties as required per AWS A5.20/A5.20M (2005) are illustrated in Table II below.

TABLE II

| | | | | Charpy V-Notch J(ft · lbf) | |
|---|---|---|---|---|---|
| | Yield Strength | Tensile Strength | Elongation | @−29° C. | @−40° C. |
| | MPa (ksi) | MPa (ksi) | % | (−20° F.) | (−40° F.) |
| Requirements - AWS E70T-5C-JH4 | 400 (58) min. | 480-655 (70-95) | 22 min. | 27 (20) min. | 27 (20) min. |
| Typical Results (as welded with | 465-510 (68-74) | 545-580 (79-84) | 29-32 | 91-142 (67-105) | 53-113 (39-83) |
| 100% CO₂) | | | | | |

The deposition composition as required per AWS A5.20/A5.20M (2005) is illustrated in Table III.

TABLE III

| | | | | | | Diffusible Hydrogen (mL/100 g weld |
|---|---|---|---|---|---|---|
| | % C | % Mn | % Si | % S | % P | deposit) |
| Requirements - AWS E70T-5C-JH4 | 0.12 | 1.75 | 0.90 | 0.03 | 0.03 | 4.0 max |
| | max. | max. | max. | max. | max. | |
| Typical Results (as welded with | 0.06-0.08 | 1.51-1.66 | 0.44-0.53 | 0.01 | 0.01 | 2-4 |
| 100% CO₂) | | | | | | |

Typical operating procedures for the flat and horizontal welding position are as follows in Table IV.

TABLE IV

| Diameter, | | Wire Feed | | | | |
|---|---|---|---|---|---|---|
| polarity | CTWD | Speed | Voltage | Approx. Current | Melt-Off Rate | Deposition Rate |
| Shielding Gas | mm (in) | m/min (in/min) | (volts) | (amps) | Kg/hr (lb/hr) | Kg/hr (lb/hr) |
| 1/16″ (1.6 mm), | 19-25 | 5.1 (200) | 29-34 | 230 | 4.0 (8.7) | 3.1 (6.9) |
| DC+, 100% CO₂ | (¾-1) | 6.4 (250) | 31-36 | 270 | 5.0 (11.101) | 3.8 (8.5) |
| | | 7.6 (300) | 32-37 | 295 | 5.9 (13.1) | 4.5 (10.0) |
| | | 8.9 (350) | 33-38 | 335 | 6.9 (15.2) | 5.5 (12.1) |
| | | 10.2 (400) | 33-38 | 360 | 7.9 (17.4) | 6.3 (13.9) |
| | | 12.7 (500) | 35-40 | 415 | 9.9 (21.8) | 7.9 (17.5) |
| 5/64″ (2.0 mm), | 25-32 | 5.1 (200) | 29-34 | 295 | 5.7 (12.7) | 4.8 (10.5) |
| DC+, 100% CO₂ | (1-1¼) | 6.4 (250) | 30-35 | 345 | 7.2 (15.9) | 6.0 (13.2) |
| | | 7.6 (300) | 32-37 | 390 | 8.6 (19.0) | 7.1 (15.6) |
| | | 8.9 (350) | 33-38 | 425 | 10.1 (22.3) | 8.5 (18.7) |
| | | 10.2 (400) | 34-39 | 465 | 11.5 (25.3) | 9.9 (21.8) |
| 3/32″ (2.4 mm), | 32 | 3.2 (125) | 23-28 | 335 | 5.5 (12.2) | 4.8 (10.7) |
| DC+, 100% CO₂ | (1⅜) | 5.1 (200) | 27-32 | 445 | 8.8 (19.3) | 7.6 (16.7) |
| | | 6.4 (250) | 29-34 | 500 | 10.9 (24.1) | 9.6 (21.3) |
| | | 7.6 (300) | 31-36 | 590 | 13.2 (29.2) | 11.8 (26.0) |
| | | 8.3 (325) | 32-37 | 605 | 14.2 (31.4) | 12.8 (28.3) |

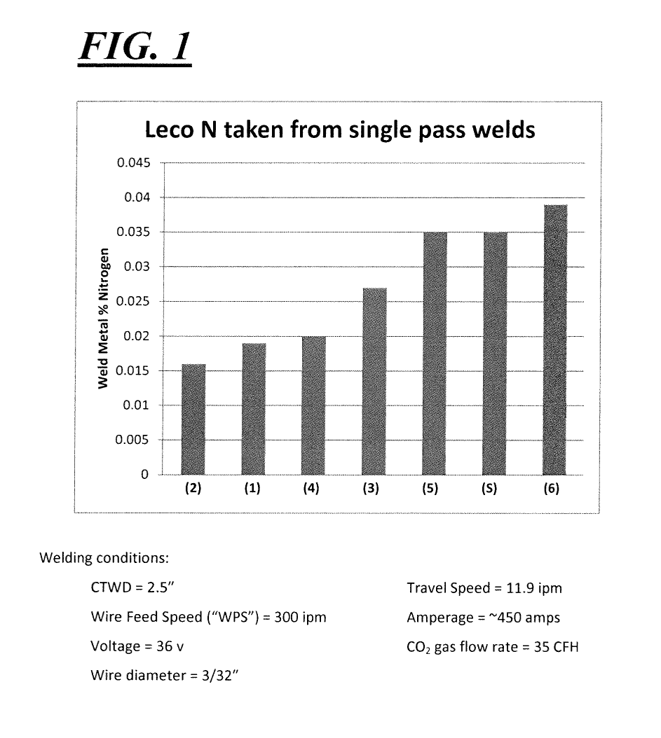

A comparative set of examples were made (see Table V) and a subset tested to illustrate decreased porosity as illustrated in FIG. 1.

TABLE V

| | (S) | (1) | (2) | (3) | (4) | (7) | (8) | (9) | (10) | (11) | (12) | (13) | (5) | (6) |
|---|---|---|---|---|---|---|---|---|---|---|---|---|---|---|
| Component | Parts | Parts | Parts | Parts | Parts | Parts | Parts | Parts | Parts | Parts | Parts | Parts | Parts | Parts |
| Cast Iron | 3.5-5 | 4.20 | | 4.20 | 4.20 | 4.20 | 3.00 | 3.00 | 3.00 | 3.00 | 3.00 | 3.00 | 4.20 | 4.20 |
| Powder | | | | | | | | | | | | | | |
| Al | | | | | | 2.00 | | | | 0.75 | 0.75 | | 2.00 | 1.00 |
| Fe | 50-60 | 52.55 | 54.75 | 51.10 | 50.10 | 50.55 | 57.00 | 57.70 | 57.50 | 57.45 | 56.85 | 56.00 | 50.55 | 54.10 |
| LiF | | | | | 1.00 | | | | | | | 1.00 | | |
| Al/Zr alloy | | | | 4.00 | 4.00 | | | 2.00 | 3.00 | 2.00 | | | | |
| Ca/Si/Ba | | | | 2.10 | 2.10 | | | 2.10 | 2.10 | 2.10 | | | | 2.10 |
| alloy | | | | | | | | | | | | | | |
| TiO₂ | 0.4-1.0 | 0.70 | 0.70 | 0.70 | 0.70 | 0.70 | 0.70 | 0.70 | 0.70 | 0.70 | 0.70 | 0.70 | 0.70 | 0.70 |
| Mn Ore | 3.2-4.2 | 3.80 | 3.80 | 3.80 | 3.80 | 3.80 | 3.80 | 3.80 | 3.80 | 3.80 | 3.80 | 3.80 | 3.80 | 3.80 |
| (some Al) | | | | | | | | | | | | | | |
| Fe/Si | 0.15-0.35 | 0.25 | 0.25 | | | 0.25 | | | | | | | 0.25 | |
| alloy | | | | | | | | | | | | | | |
| Fe/Mn/Si | 8.6-12.60 | 10.60 | 10.60 | 7.00 | 7.00 | 10.60 | 8.60 | 4.00 | 3.00 | 3.50 | 8.00 | 8.60 | 10.60 | 7.00 |
| alloy | | | | | | | | | | | | | | |
| CaF₂ | 18-22 | 20.20 | 20.20 | 20.20 | 20.20 | 20.20 | 20.20 | 20.20 | 20.20 | 20.20 | 20.20 | 20.20 | 20.20 | 20.20 |
| K₂TiO₃ | 3.0-7.0 | 4.70 | 4.70 | 4.70 | 4.70 | 4.70 | 4.70 | 4.70 | 4.70 | 4.70 | 4.70 | 4.70 | 4.70 | 4.70 |
| Mn | | | | 2.20 | 2.20 | | | 1.80 | 2.00 | 1.80 | | | | 2.20 |
| Li₂CO₃ | | | 2.00 | | | | | | | | | | | |
| Ti | | 3.00 | 3.00 | | | 3.00 | 2.00 | | | | 2.00 | 2.00 | | |
| Mg | | | | | | | | | | | | | 3.00 | |
| Totals (parts) | 100 | 100 | 100 | 100 | 100 | 100 | 100 | 100 | 100 | 100 | 100 | 100 | 100 | 100 |

In the above table, (S) represents a standard T5 welding electrode as sold by the Lincoln Electric Company and at least examples (1) through (4) exhibit reduced porosity. Examples (7) through (13) are anticipated to also exhibit reduced porosity. Examples (5) and (6) performed no better than a standard T5 flux cored shielded welding electrode. As illustrated in FIG. 1, when welding out of the recommended specifications illustrated in Table IV, the porosity was unacceptable.

In FIG. 1, samples 1-4 performed better than the standard T5 electrode (S) as well better than comparative test compositions 5-6, the compositions of which are found in Table IV, the best composition to date showing a 52% reduction in nitrogen in the weld metal as compared to the standard T5 electrode (S). Samples 7-13 are anticipated to perform better than the standard electrode (S).

The inclusion of metallic nitride formers, e.g., the addition of at least one metallic Ti, Zr, Ca, Ba and Al, including metallic alloys thereof or alloys which incorporate at least one of the identified metals, into the standard composition UltraCore® 75C flux-cored electrode resulted in a reduced porosity attributable at least in part to nitrogen by between approximately 25-55% as compared with the standard UltraCore® 75C flux-cored electrode product. It is noted that UltraCore® 75C flux-cored electrodes do not pass the porosity test illustrated in the legend to Table VI. In the absence of Al in the electrode, it is possible to substitute lithium carbonate (Li₂CO₃) and lithium fluoride (LiF). A further set of experimental results are illustrated in Table VI.

TABLE VI
Table VI (nominal percent fill is 25.5%)

| | (S) | (14) | (15) | (16) | (17) | (18) | (19) | (20) |
|---|---|---|---|---|---|---|---|---|
| Component | Parts | | | | | | | |
| Cast Iron Powder | 3.5-5 | 3.00 | 1.50 | 1.50 | 1.50 | | | |
| Al | | 0.75 | 0.75 | 0.75 | 0.75 | 0.75 | 0.75 | 0.50 |
| Fe | 50-60 | 56.85 | 58.85 | 59.35 | 59.85 | 60.35 | 61.35 | 61.10 |
| TiO₂ | 0.4-1.0 | 0.70 | 0.70 | 0.70 | 0.70 | 0.70 | 0.70 | 0.70 |
| Mn Ore (some Al) | 3.2-4.2 | 3.80 | 3.80 | 3.80 | 3.80 | 3.80 | 3.80 | 3.80 |
| Fe/Si alloy | 0.15-0.35 | | | | | | | |
| Fe/Mn/Si alloy | 8.6-12.60 | 8.00 | 8.00 | 8.00 | 8.00 | 8.00 | 8.00 | 8.00 |
| CaF₂ | 18-22 | 20.20 | 20.20 | 20.20 | 20.20 | 20.20 | 20.20 | 20.20 |
| K₂TiO₃ | 3.0-7.0 | 4.70 | 4.70 | 4.70 | 4.70 | 4.70 | 4.70 | 4.70 |
| Ti | | 2.00 | 1.50 | 1.00 | 0.50 | 1.50 | 0.50 | 1.00 |
| Totals | 100 | 100 | 100 | 100 | 100 | 100 | 100 | 100 |

Physicals

| | | | | | | | | |
|---|---|---|---|---|---|---|---|---|
| 0.2% Yield (ksi) | 58 (min) | 79.8 | 77.3 | 79.2 | 76.9 | 81.7 | 80.2 | 73.9 |
| Tensile (ksi) | 70-95 | 92.2 | 89.2 | 91.0 | 88.8 | 93.8 | 90.7 | 85.4 |
| % elongation | 22 (min) | 25 | 26 | 19 | 23 | 25 | 27 | 28 |
| Charpy Impact (−20° F.) (ft-lbs) | | 55 | 67 | 36 | 31 | 36 | 59 | 38 |
| Charpy Impact (−40° F.) (ft-lbs) | 20 (min) | 24 | 22 | 30 | 19 | 22 | 39 | 33 |

Weld Metal Chemistry

| | | | | | | | | |
|---|---|---|---|---|---|---|---|---|
| C | 0.12 (max) | 0.07 | 0.05 | 0.07 | 0.07 | 0.06 | 0.07 | 0.06 |
| Mn | 1.75 (max) | 1.51 | 1.54 | 1.55 | 1.43 | 1.53 | 1.49 | 1.41 |
| Si | 0.9 (max) | 0.50 | 0.51 | 0.48 | 0.41 | 0.48 | 0.44 | 0.43 |
| S | 0.03 (max) | 0.01 | 0.01 | 0.01 | 0.01 | 0.01 | 0.01 | 0.01 |
| P | 0.03 (max) | 0.01 | 0.01 | 0.01 | 0.01 | 0.01 | 0.01 | 0.01 |
| N | | 0.0052 | 0.0090 | 0.0073 | 0.0087 | 0.0054 | 0.0167 | 0.0050 |
| O | | 0.0633 | 0.0732 | 0.0594 | 0.0662 | 0.0583 | 0.0795 | 0.0530 |
| Cu | | 0.036 | 0.048 | 0.098 | 0.089 | 0.093 | 0.103 | 0.072 |
| Ni | | 0.0310 | 0.0240 | 0.0450 | 0.0390 | 0.0410 | 0.0460 | 0.0230 |
| Al | report | 0.032 | 0.038 | 0.042 | 0.062 | 0.041 | 0.045 | 0.029 |
| Ti | | 0.0748 | 0.0827 | 0.0563 | 0.0318 | 0.0784 | 0.0350 | 0.0594 |
| Diffusible hydrogen | 4.0 (max) | <4 | <4 | <4 | <4 | <4 | <4 | <4 |
| (mL/100 g weld deposit) | | | | | | | | |

*WFS (ipm) = 300; CTWD (in) = 2 1/2 ; Voltage = 36; Travel speed (ipm) = 11.9; current = 450 (approx.); gas flow rate (cfh) = 35

A further set of experiments are characterized in Table VII, illustrating the inclusion of rare earth metals, including rare earth silicides and oxides.

TABLE VII
Table VII (nominal percent fill is 25.5%)

| | (S) | (21) | (22) | (23) | (24) | (25) | (26) | (27) |
|---|---|---|---|---|---|---|---|---|
| Component | Parts | | | | | | | |
| Al | | 0.75 | 0.75 | 0.50 | 0.50 | 0.50 | 0.50 | 0.50 |
| Fe | 50-60 | 61.35 | 60.85 | 57.10 | 59.10 | 60.20 | 59.80 | 57.80 |
| Mn | | | | 4.00 | 2.00 | 1.10 | | |
| TiO₂ | 0.4-1.0 | 0.70 | 0.70 | 0.70 | 0.70 | 0.70 | | |
| Mn Ore (some Al) | 3.2-4.2 | 3.80 | 3.80 | 3.80 | 3.80 | 3.80 | 3.80 | 3.80 |
| Fe/Mn/Si alloy | 8.6-12.60 | 8.00 | 8.00 | | 4.00 | 5.80 | 8.00 | 8.00 |
| CaF₂ | 18-22 | 20.20 | 20.20 | 20.20 | 20.20 | 20.20 | 20.20 | 20.20 |
| K₂TiO₃ | 3.0-7.0 | 4.70 | 4.70 | 4.70 | 4.70 | 4.70 | 4.70 | 4.70 |
| Ti | | 0.50 | 1.00 | 1.00 | 1.00 | 1.00 | 1.00 | 1.00 |
| Rare Earth Silicide⁽¹⁾ | | | | 8.00 | 4.00 | 2.00 | | |
| CeO₂ | | | | | | | 2.00 | 4.00 |
| Totals | 100 | 100 | 100 | 100 | 100 | 100 | 100 | 100 |
| Slag composition | 25.60% | 25.60% | 25.60% | 25.60% | 25.60% | 25.60% | 24.90% | 24.90% |
| Metallic composition | 74.40% | 74.40% | 74.40% | 74.40% | 74.40% | 74.40% | 75.10% | 75.10% |
| CaF % of slag | 78.90% | 78.90% | 78.90% | 78.90% | 78.90% | 78.90% | 81.10% | 81.10% |

*WFS (ipm) = 300; CTWD (in) = 2 1/2 ; Voltage = 36; Travel speed (ipm) = 11.9; current = 450 (approx.); gas flow rate (cfh) = 35
⁽¹⁾As used in this application, Rare Earth Silicide will have the approximate composition as illustrated in Table VIII.

TABLE VIII

| Element | Percentage | Element | Percentage | |
|---|---|---|---|---|
| Si | Bal. | Pr | 1-2% | |
| Re | 29-35% | C | 1% | max. |
| Fe | 26-33% | Mo | 1% | max. |
| Ce | 14-18% | P | 0.2% | max. |
| La | 9-12% | S | 0.2% | max. |
| Nd | 4-5% | Ti | 0.1% | max |

In one specific analysis of Rare Earth Silicides, the following composition was experimentally determined as illustrated in Table IX.

TABLE IX

| Element | % | Range % | Element | % | Range % | Element | % | Range % | Element | % | Range % |
|---|---|---|---|---|---|---|---|---|---|---|---|
| Mo | 0.016 | 0-1 | Fe | Bal. | Bal. | P | 0.17 | 0-1 | Sm | 0.20 | 0-1 |
| Si | 34.24 | 30-40 | Ga | 0.008 | 0-1 | Tb | 0.004 | 0-1 | Nd | 4.68 | 0-8 |
| Sr | 0.11 | 0-1 | Al | 0.20 | 0-1 | Th | 0.046 | 0-1 | Pr | 1.58 | 0-5 |
| Ti | 0.041 | 0-1 | Ca | 0.40 | 0-1 | Gd | 0.073 | 0-1 | Eu | 0.014 | 0-1 |
| V | 0.002 | 0-1 | Co | 0.002 | 0-1 | Ho | 0.001 | 0-1 | La | 11.37 | 5-20 |
| Mg | 0.017 | 0-1 | Cr | 0.094 | 0-1 | Dy | 0.009 | 0-1 | Ba | 0.19 | 0-1 |
| Mn | 0.29 | 0-1 | Cu | 0.022 | 0-1 | Er | 0.001 | 0-1 | Ce | 17.25 | 5-30 |
| Ni | 0.016 | 0-1 | U | 0.004 | 0-1 | W | 0.20 | 0-1 | Y | 0.018 | 0-1 |

It is believed that the inclusion of at least one rare earth silicide and/or at least one rare earth oxide, preferably combinations thereof, improves the characteristics of the final weld product as illustrated in Table VII.

The best mode for carrying out the invention has been described for purposes of illustrating the best mode known to the applicant at the time. The examples are illustrative only and not meant to limit the invention, as measured by the scope and merit of the claims. The invention has been described with reference to preferred and alternate embodiments. Obviously, modifications and alterations will occur to others upon the reading and understanding of the specification. It is intended to include all such modifications and alterations insofar as they come within the scope of the appended claims or the equivalents thereof.

What is claimed is:

1. A process to reduce the porosity of a weld bead using a flux-cored shielded T5 electrode, said weld made from the T5 electrode having a diffusible hydrogen as measured in mL/100 g weld deposit of less than or equal to 4.0 comprising the step of:
adding between 0.25-10 parts of at least one porosity reducing agent to the electrode composition comprising a lime-fluoride based slag, selected from the group consisting of
(a) at least one metallic nitride former selected from the group consisting of Ti, Zr, Ca, Ba and Al, including metallic alloys thereof or alloys which incorporate at least one of the identified metals, and further wherein
when no Al is present in the at least one metallic nitride former, a Li compound is substituted; or
(b) at least one rare earth metal selected from the group consisting of La, Ce, Pr, Nd, Pm, Sm, Eu, Gd, Tb, Dy, Ho, Er, Tm, Yb, Lu, Sc and Y;
including combinations of (a) and (b).

2. The process of claim 1, wherein
the Li compound is selected from the group consisting of Li₂CO₃ and LiF.

3. The process of claim 2, wherein
the Li compound is LiF.

4. The process of claim 1 wherein,
the metallic alloys of the at least one nitride former comprise an Al/Zr powder alloy and a Ca/Si/Ba powder alloy.

5. The process of claim 1 wherein,
the at least one rare earth metal is selected from the group consisting of cerium and lanthanum.

6. The process of claim 1 wherein the flux-cored shielded T5 electrode comprises:

| Component | Parts |
|---|---|
| Cast Iron Powder | 3.5-5 |
| Fe | 50-60 |
| TiO₂ | 0.4-1.0 |
| Mn | 3.2-4.2 |
| Ferro Silicon (47-52% Si) | 0.15-0.35 |
| Ferromanganese Silicon (59-63% Mn/29-32% Si) | 8.6-12.6 |
| CaF₂ | 18-22 |
| K₂TiO₃ | 3.0-7.0 |
| at least one porosity reducer agent | 0.25-10.0 |
| Totals | 100. |

7. A flux-cored shielded electrode having a diffusible hydrogen in a weld derived from the electrode of less than or equal to 4.0 mL/100 g weld deposit, the electrode comprising at least one porosity reducing agent, the electrode forming a lime-fluoride based slag, the at least one porosity reducing agent selected from the group consisting of
(a) at least one metallic nitride former selected from the group consisting of Ti, Zr, Ca, Ba and Al, including metallic alloys thereof or alloys which incorporate at least one of the identified metals, and further wherein
when no Al is present in the at least one metallic nitride former, a Li compound is substituted; or
(b) at least one rare earth metal selected from the group consisting of La, Ce, Pr, Nd, Pm, Sm, Eu, Gd, Tb, Dy, Ho, Er, Tm, Yb, Lu, Sc and Y,
including combinations of (a) and (b).

8. The flux-cored shielded electrode of claim 7, wherein
the Li compound is selected from the group consisting of Li₂CO₃ and LiF.

9. The flux-cored shielded electrode of claim 8, wherein
the Li compound is LiF.

10. The flux-cored shielded electrode of claim 7 wherein,
the metallic alloys of the at least one nitride former comprise an Al/Zr powder alloy and a Ca/Si/Ba powder alloy.

11. The flux-cored shielded electrode of claim 7 wherein,
the at least one rare earth metal is selected from the group consisting of lanthanum and cerium.

12. A process to reduce the porosity of a weld bead using a flux-cored shielded T5 electrode, said weld made from the T5 electrode having a diffusible hydrogen as measured in mL/100 g weld deposit of less than or equal to 4.0 comprising the step of:
adding between 0.25-10 parts of at least one porosity reducing agent to the electrode composition comprising a lime-fluoride based slag, the at least one porosity reducing agent comprising at least one rare earth metal selected from the group consisting of La, Ce, Pr, Nd, Pm, Sm, Eu, Gd, Tb, Dy, Ho, Er, Tm, Yb, Lu, Sc and Y.

13. The process of claim 11 wherein the flux-cored shielded electrode further comprises:
a Li compound selected from the group consisting of Li₂CO₃ and LiF.

14. The process of claim 13, wherein
the Li compound is LiF.

15. The process of claim 13 wherein,
the at least one rare earth metal is selected from the group consisting of cerium and lanthanum.

16. The flux-cored shielded electrode having a diffusible hydrogen in a weld derived from the electrode of less than or equal to 4.0 mL/100 g weld deposit, the electrode comprising at least one porosity reducing agent, the electrode forming a lime-fluoride based slag, and wherein the at least one porosity reducing agent comprises:
at least one rare earth metal selected from the group consisting of La, Ce, Pr, Nd, Pm, Sm, Eu, Gd, Tb, Dy, Ho, Er, Tm, Yb, Lu, Sc and Y.

17. The flux-cored shielded electrode of claim 16 which further comprises:
a Li compound is selected from the group consisting of Li₂CO₃ and LiF.

18. The flux-cored shielded electrode of claim 17, wherein
the Li compound is LiF.

19. The flux-cored shielded electrode of claim 17 wherein,
the at least one rare earth metal is selected from the group consisting of lanthanum and cerium.
